(19) United States
(12) Patent Application Publication
(10) Pub. No.: US 2011/0176557 A1
(43) Pub. Date: Jul. 21, 2011

(54) APPARATUS AND METHOD FOR CONTROLLING BUFFER USING PLAY TIME AS IMAGE TRANSMISSION

(75) Inventors: Seong-Jun Bae, Daejeon (KR); Jeong Ju Yoo, Daejeon (KR); Jin Woo Hong, Daejeon (KR); Sung Jea Ko, Seoul (KR); Hye Soo Kim, Seoul (KR); Hyung Min Nam, Seoul (KR)

(73) Assignee: Electronics and Telecommunications Research Institute, Daejeon (KR)

(21) Appl. No.: 13/120,244

(22) PCT Filed: Jul. 6, 2009
(86) PCT No.: PCT/KR2009/003681

§ 371 Date: Mar. 22, 2011

(30) Foreign Application Priority Data
Sep. 23, 2008 (KR) 10-2008-0093227

(51) Int. Cl. H04J 99/00

(52) U.S. Cl. 370/476

(57) ABSTRACT

Disclosed is a buffer controlling apparatus and method using a play time during image transmission. The buffer controlling method using the play time during the image transmission includes controlling a transmission bit rate with respect to packets to be transmitted to a reception buffer based on bit capacity with respect to packets of the reception buffer, controlling a number of transmission frames with respect to the packets to be transmitted to the reception buffer based on a play time with respect to the packets of the reception buffer, and generating the packets to be transmitted corresponding to the transmission bit rate and the number of the transmission frames, and transmitting the generated packets to the reception buffer.

### TECHNICAL FIELD

The present invention relates to an apparatus and method for controlling a buffer using a play time while an image is transmitted, and more particularly, an apparatus and method for controlling a buffer, which can controls underflow of the buffer.

### BACKGROUND ART

A conventional buffer controlling method only considers a size of a reception buffer when preventing underflow and overflow of the reception buffer. That is, a server end receives information concerning how much data is accumulated in a buffer from a client end and controls a transmission rate of an image when the data is near to an upper bound of the buffer.

The buffer controlling method may be applied when a channel condition is good. However, the method is difficult to be applied to a network where a channel condition varies over time such as in a wireless network. When data is received late or is lost due to a bad channel condition, underflow of the buffer may occur. In this instance, transmitting the data at a higher rate to control the underflow of the buffer is not appropriate in a network having a narrow bandwidth such as the wireless network.

Also, when it is impossible to receive data for a certain time, for example, when handoff is performed, a circumstance where data is output from the buffer while no data is input to the buffer may occur. In this instance, when the size of the buffer is merely considered, underflow of the buffer is unavoidable during this period and an image has a high possibility of being disconnected while replayed.

Accordingly, a buffer controlling method for transmitting packets without disconnection of an image in a network where a channel condition varies over time is required.

### DISCLOSURE OF INVENTION

### Technical Problem

An aspect of the present invention provides a buffer controlling apparatus and method for controlling underflow of a buffer through using a play time while an image is transmitted.

### Technical Solution

According to an aspect of the present invention, there is provided an apparatus for controlling a buffer using a play time during image transmission, the apparatus including a transmission bit rate controller to control a transmission bit rate with respect to packets to be transmitted to a reception buffer based on bit capacity with respect to packets of the reception buffer, and a transmission frame controller to control a number of transmission frames with respect to the packets to be transmitted to the reception buffer based on a play time with respect to the packets of the reception buffer.

According to an aspect of the present invention, there is provided a method for controlling a buffer using play time during image transmission, the method including controlling a transmission bit rate with respect to packets to be transmitted to a reception buffer based on bit capacity with respect to packets of the reception buffer, controlling a number of transmission frames with respect to the packets to be transmitted to the reception buffer based on a play time with respect to the packets of the reception buffer, and generating the packets to be transmitted corresponding to the transmission bit rate and the number of the transmission frames, and transmitting the generated packets to the reception buffer.

### BRIEF DESCRIPTION OF DRAWINGS

FIG. 1 is a block diagram illustrating a buffer control system where a buffer controlling apparatus is applied using a play time while an image is transmitted according to an example embodiment of the present invention;

FIG. 2 illustrates a Real Time Control Protocol application (RTCP APP) packet that transfers available bandwidth (AB) and Nₖ according to an example embodiment of the present invention;

FIG. 3 illustrates a conventional RTCP APP packet suggested by 3GPP-SA4; and

FIG. 4 is a flowchart illustrating a buffer controlling method using a play time while an image is transmitted according to an example embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

Hereinafter, a buffer controlling apparatus and method using a play time while an image is transmitted will be described in detail.

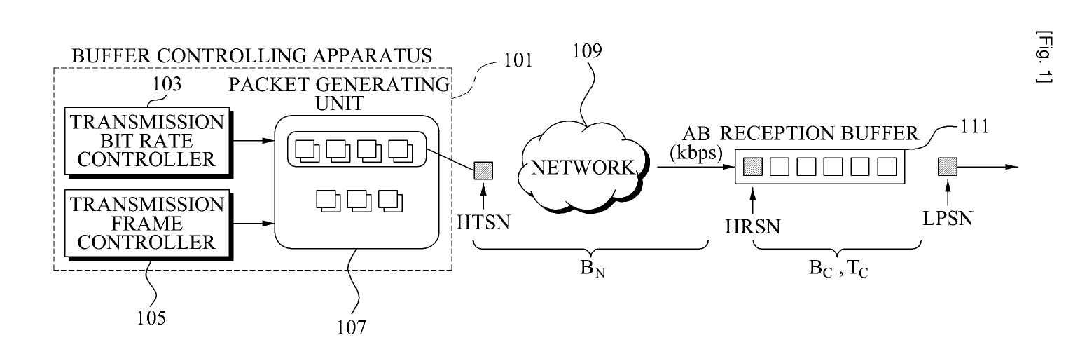

FIG. 1 is a block diagram illustrating a buffer control system where a buffer controlling apparatus is applied using a play time while an image is transmitted according to an example embodiment of the present invention.

Referring to FIG. 1, the buffer control system includes a buffer controlling apparatus 101 and reception buffer 111. Here, the buffer controlling apparatus 101 and the reception buffer 111 are respectively applied to a server end and a client end.

The buffer controlling apparatus 101 includes a transmission bit rate controller 103, transmission frame controller 105, and a packet generating unit 107.

The transmission bit rate controller 103 may control a transmission bit rate with respect to packets to be transmitted to the reception buffer 111 based on bit capacity with respect to packets of the reception buffer 111. Here, the bit capacity B_{c} with respect to the packets of the reception buffer 111 may be expressed by Equation 1.

$${B}_{C} = {\sum }_{i = LPSN}^{HRSN} {S}_{i} \qquad [ Equation 1 ]$$

Here, Highest Received Sequence Number (HRSN) represents a packet number that is most recently inputted to the reception buffer 111, and Last Played Sequence Number (LPSN) represents a packet number that is most recently outputted from the reception buffer 111. Also, Sᵢ represents a size of each packet.

Each parameter may be fed back at regular intervals from the client end including the reception buffer.

Specifically, the bit capacity B_{C} with respect to the packets of the reception buffer 111 based on a bit capacity threshold B_{T} may be expressed by Equation 2.

$${B}_{C} = \{ \begin{matrix}{\sum }_{i = LPSN}^{HRSN} {S}_{i} + {T}_{e} \cdot AB - {\sum }_{i = 1}^{⌊ f \cdot {T}_{e} ⌋} {S}_{LPSN + i} \leq {B}_{T} , & {B}_{N} \geq AB \cdot {T}_{e} \\ {\sum }_{i = LPSN}^{HTSN} {S}_{i} - {\sum }_{i = 1}^{⌊ f \cdot {T}_{e} ⌋} {S}_{LPSN + i} + {R}_{S} \cdot {T}_{r} \leq {B}_{T} , & {B}_{N} < AB \cdot {T}_{e}\end{matrix} \qquad [ Equation 2 ]$$

Here, HTSN represents a packet number that is most recently outputted from the buffer controlling apparatus 101, and f relates to periods at which the buffer controlling apparatus 101 transmits a packet to a network 109 and is also defined as a frame rate. T_{c} represents a time remaining until a buffer controlling apparatus receive a next feedback signal. Rₛ represents a bit rate at which packets are generated in the buffer controlling apparatus 101, which indicates a transmission bit rate. Tᵣ represents a time remaining after all packets existing in the network 109 are transmitted at a feedback period. Tᵣ may be expressed by Equation 3.

Tᵣ=Tₑ−B_{N}/AB [Equation 3]

Here, AB represents an available bandwidth of the network 109. Also, B_{N} represents bit capacity with respect to the packets existing in the network 109, which may be expressed by Equation 4.

$${B}_{N} = {\sum }_{i = HRSN}^{HTSN} {S}_{i} \qquad [ Equation 4 ]$$

The transmission bit rate controller 103 may lower the transmission bit rate R_{S}, when bit capacity B_{C} with respect to the packets of the reception buffer 111 is greater than a threshold B_{T} of the reception buffer 111. This is to minimize a loss of the packets through lowering the transmission bit rate R_{S}, since the loss the packets may be caused by overflow of the reception buffer 111.

The transmission frame controller 105 may control a number of transmission frames with respect to the packets to be transmitted to the reception buffer 111 based on a play time with respect to the packets of the reception buffer 111. Here, the play time T_{C} with respect to the packets of the reception buffer 111 may be expressed by Equation 5.

$${T}_{C} = {\sum }_{i = LPSN}^{HRSN} \frac{1}{{f}_{i}} \qquad [ Equation 5 ]$$

Here, f represents a frame rate of an image.

Specifically, the play time T_{C} with respect to the packets of the reception buffer 111 based on the play time threshold T_{T} may be expressed by Equation 6.

$${T}_{C} = \{ \begin{matrix}{\sum }_{i = LPSN}^{HRSN} \frac{1}{{f}_{i}} - {T}_{e} - {\sum }_{i = 1}^{Ni} \frac{1}{{f}_{i}} \geq {T}_{T} , & {B}_{N} \geq AB \cdot {T}_{e} \\ \begin{matrix}{\sum }_{i = LPSN}^{HRSN} \frac{1}{{f}_{i}} + {\sum }_{i = HRSN}^{HTSN} \frac{1}{{f}_{i}} - {T}_{e} + {\sum }_{i = HTSN}^{{N}_{k}} \frac{1}{{f}_{i}} = \\ {\sum }_{i = LPSN}^{HTSN} \frac{1}{{f}_{i}} - {T}_{e} + {\sum }_{i = HTSN}^{{N}_{k}} \frac{1}{{f}_{i}} \geq {T}_{T} ,\end{matrix} & {B}_{N} < AB \cdot {T}_{e}\end{matrix} \qquad [ Equation 6 ]$$

Here, Nᵢ represents a number of packets to be outputted from the reception buffer 111 during a feedback period. Nₖ represents a number of packets to be generated during a certain time Tᵣ at a transmission rate R_{S}. Nᵢ and Nₖ may satisfy a required condition of Equation 7.

$$\{ {N}_{i} \vert {\sum }_{i = HRSN}^{{N}_{i}} {S}_{i} \leq AB \cdot {T}_{e} \} \\ \{ {N}_{k} \vert {\sum }_{i = HRSN}^{{N}_{k}} {S}_{i} \leq {R}_{s} \cdot {T}_{r} \} \qquad [ Equation 7 ]$$

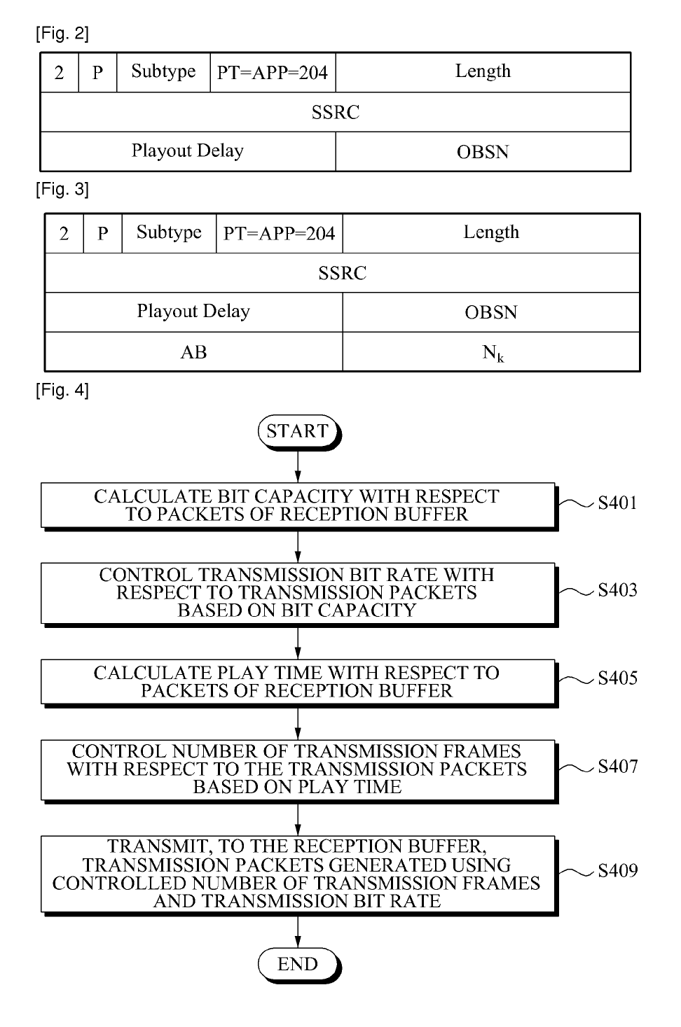

In this instance, AB and Nₖ may receive a Real Time Control Protocol application (RTCP APP) packet of FIG. 2 from the client end including the reception buffer, and the RTCP APP packet is made through additionally inserting the AB and Nₖ to an existing RTCP APP packet of FIG. 3.

The transmission frame controller 105 may increase the number of transmission frames, when the play time T_{c} is less than a play time threshold T_{T}. Since replaying of the image may have a possibility of being disconnected due to underflow of the reception buffer 111, the transmission frame controller 105 reduces a bit capacity per frame, and thereby can transmit many more frames.

For example, when it is assumed that the buffer controlling apparatus 101 transmits N frames at a transmission bit rate R_{S} during a time Tₑ remaining until the buffer controlling apparatus 101 receive a next feedback from a present time, a bit rate per frame is R_{S} Tₑ/N.

In this instance, when the transmission frame controller 105 does not satisfy Equation 6 with the bit rate per frame, R_{S} Tₑ/N, underflow of the reception buffer 111 may be expected. Accordingly, the transmission frame controller 105 reduces the bit rate per frame to one half of the R_{S} Tₑ/N and transmits 2N frames which is twice as much as N frames, thereby satisfying Equation 6.

The transmission frame controller 105 may control the number of transmission frames even when an expected channel condition is not good. Thus, the transmission frame controller 105 may support a sufficient play time using only data stored in the reception buffer 111, although input to the reception buffer 111 is relatively small. Accordingly, it may provide the image without disconnection.

Specifically, when only a required condition of Equation 2 is satisfied in the buffer controlling apparatus 101, and a quantity of data in the reception buffer is as much as data that may be utilized in a short time, even if the reception buffer 111 is full of data, replaying of the image may be disconnected. For example, it is assumed that data is not inputted for 200 ms, such as during a handoff, and quantity of data in the reception buffer 111 is as much as five frames, even with the reception buffer 111 being full of image packets. Then, when frame rate of an encoded image is 30 fps, underflow of the reception buffer 111 may occur within 5×1/30×1000=167 ms.

In this case, the transmission frame controller 105 may control the number of transmission frames, and thus the reception buffer 111 may not have five frames worth of data, but may have as much as 10 frames worth of data. Accordingly, the transmission frame controller 105 may support a play time, thereby providing an image service without disconnection.

That is, the transmission frame controller 105 controls the play time of data existing in the reception buffer 111 to be more than a certain standard (e.g. minimum 200 ms), thereby enabling the image to be displayed without disconnection.

The transmission bit rate controller 103 and transmission frame controller 105 may be included in an existing extractor of Scalable Video Codec (SVC) or a codec capable of real time encoding.

The packet generating unit 107 generates a transmission packet according to a transmission bit rate and a number of transmission frames controlled by the transmission bit rate controller 103 and transmission frame controller 105, and transmits the generated transmission packet to the reception buffer 111.

According to example embodiments, a buffer controlling apparatus controls a transmission bit rate to control overflow of a reception buffer, and controls a number of transmission frames within the transmission bit rate to control the underflow of the reception buffer and simultaneously to support sufficient play time. Accordingly, the buffer controlling apparatus may support replaying of an image without disconnection, even when a channel condition is not good.

FIG. 4 is a flowchart illustrating a buffer controlling method using a play time while an image is transmitted according to an example embodiment of the present invention.

Referring to FIG. 4, the buffer controlling apparatus using a play time during image transmission calculates a bit capacity with respect to packets of a reception buffer in operation S401.

In this instance, the buffer controlling apparatus may calculate the bit capacity with respect to the packets of the reception buffer through Equation 2.

Next, the buffer controlling apparatus controls a transmission bit rate with respect to transmission packets based on the bit capacity with respect to the packets of the reception buffer in operation 5403.

Specifically, the buffer controlling apparatus may control the transmission bit rate with respect to the packets to be transmitted to the reception buffer to be lower, when the bit capacity with respect to the packets of the reception buffer is greater than a predetermined bit capacity threshold. This is to reduce loss of the packets, since overflow of the reception buffer is expected.

Next, the buffer controlling apparatus calculates a play time with respect to the packets of the reception buffer in operation 5405.

In this instance, the buffer controlling apparatus may calculate the play time with respect to the packets of the reception buffer through Equation 6.

Next, the buffer controlling apparatus controls a number of transmission frames with respect to the transmission packets based on the play time with respect to the packets of the reception buffer in operation 5407.

Specifically, the buffer controlling apparatus may control the number of the transmission frames with respect to the transmission packets to be higher, when the play time with respect to the packets of the reception buffer is less than a predetermined play time threshold. This is to prevent disconnecting an image when replayed, since overflow of the reception buffer is expected.

Next, the buffer controlling apparatus generates transmission packets corresponding to the controlled transmission bit rate and the number of transmission frames, and transmits the generated transmission packets to the reception buffer in operation 5409.

The buffer controlling apparatus may control the transmission bit rate and the number of transmission frames in real time and transmit the transmission packets corresponding thereto, thereby transmitting packets so as to not disconnect replaying of image, even when a channel condition is not good.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for controlling a buffer, the method comprising:
controlling a transmission bit rate with respect to packets to be transmitted to a reception buffer based on bit capacity with respect to packets of the reception buffer;
controlling a number of transmission frames with respect to the packets to be transmitted to the reception buffer based on a play time with respect to the packets of the reception buffer; and
generating the packets to be transmitted corresponding to the transmission bit rate and the number of the transmission frames, and transmitting the generated packets to the reception buffer.

2. The method of claim 1, wherein the controlling of the transmission bit rate comprises:
calculating the bit capacity with respect to the packets of the reception buffer;
controlling the transmission bit rate to be lower, when the bit capacity is greater than a predetermined bit capacity threshold.

3. The method of claim 1, wherein the controlling of the number of the transmission frames comprises:
calculating the play time with respect to the packets of the reception buffer; and
controlling the number of the transmission frames to be higher, when the play time is less than a predetermined play time threshold.

4. The method of claim 1, further comprising:
receiving, from the reception network, an available bandwidth (AB) of a network and a number of packets that are generated during a certain time at the transmission bit rate,
wherein the controlling of the number of the transmission frames controls the number of the transmission frames to be transmitted to the reception buffer based on the AB of the network and the number of packets that are generated during the certain time at the transmission rate.

5. An apparatus for controlling a buffer, the apparatus comprising:
a transmission bit rate controller to control a transmission bit rate with respect to packets to be transmitted to a reception buffer based on bit capacity with respect to packets of the reception buffer; and
a transmission frame controller to control a number of transmission frames with respect to the packets to be transmitted to the reception buffer based on a play time with respect to the packets of the reception buffer.

6. The apparatus of claim 5, wherein the transmission bit rate controller controls the transmission bit rate to be lower when the bit capacity with respect to the packets of the reception buffer is greater than a predetermined bit capacity threshold.

7. The apparatus of claim 5, wherein the transmission frame controller controls the number of the transmission frames to be higher when the play time with respect to the packets of the reception buffer is less than a predetermined play time threshold.
